(19) United States
(12) Patent Application Publication
(10) Pub. No.: US 2025/0190839 A1
(43) Pub. Date: Jun. 12, 2025

(54) ASYMMETRIC REPETITION CODE FOR A CAT- QUBIT

(71) Applicant: ALICE & BOB, Paris (FR)

(72) Inventors: Camille BERDOU, Paris (FR); François-Marie LE REGENT, Paris (FR); Jérémie GUILLAUD, Paris (FR); Zaki LEGHTAS, Paris (FR); Mazyar MIRRAHIMI, Paris (FR)

(21) Appl. No.: 18/846,501

(22) PCT Filed: Mar. 15, 2023
(86) PCT No.: PCT/FR2023/050363

§ 371 Date: Sep. 12, 2024

(30) Foreign Application Priority Data
Mar. 16, 2022 (FR) 2202327

(51) Int. Cl. G06N 10/70; G06N 10/20; G06N 10/40

(52) U.S. Cl. CPC G06N 10/70; G06N 10/20; G06N 10/40

(57) ABSTRACT

The disclosure relates to a repetition code for a cat qubit comprising a number d of data cat-qubits and at least ancillary cat-qubits, wherein the number d is greater than or equal to 3, each ancillary cat-qubit is connected to two data cat-qubits by two respective CNOT gates such that no data cat-qubit is connected to more than two ancillary cat-qubits, and the two-photon dissipation rate of the ancillary cat-qubits is greater than the two-photon dissipation factor of the data cat-qubits. Said repetition code is implemented by carrying out, for each ancillary cat-qubit, error correction cycles comprising at least the following steps: preparing the ancillary cat-qubit in a state suitable for the operator X: “I+>” or “I−>”; activating one of the two CNOT gates connected to said ancillary cat-qubit (6); activating the other CNOT gate connected to this ancillary cat-qubit; and measuring the photon-number parity of said ancillary cat-qubit.

### CROSS-REFERENCE TO RELATED APPLICATIONS

This present application is a national stage application of International Patent Application No. PCT/FR2023/050363, filed Mar. 15, 2023, which claims priority to French Patent Application No. FR2202327, filed Mar. 16, 2022, the disclosures of which are hereby incorporated by reference in their entireties.

### TECHNICAL FIELD

The disclosure relates to the field of quantum computing, bosonic quantum error correction codes, and repetition codes.

### BACKGROUND

Making a large-scale quantum computer is a challenge because the noise induced by the uncontrolled interactions of the components of the quantum computer with its environment destroys the fragile quantum characteristics responsible for quantum acceleration. Indeed, the algorithms for which the quantum acceleration is theoretically proven require a given level of protection against decoherence.

The theory of fault-tolerant quantum computation addresses this matter. The quantum error correcting codes (QECCs) are designed such that the errors induced by the environment do not affect the quantum information. These codes operate according to the principle of “fighting entanglement with entanglement,” wherein, since the natural errors occurring in the physical systems are generally local, the quantum information to be protected is encoded in non-local entangled states, such that it becomes unlikely that errors can corrupt it. One of the popular QECCs at the time of writing is the surface code.

The core of the quantum fault tolerance theory is the threshold theorem: arbitrarily long quantum computations could be performed reliably, provided that the noise affecting the physical components of the computer is lower than a constant value called the fault-tolerant error threshold.

In theory, when they function below the fault-tolerant error threshold, the QECCs provide an arbitrarily good protection against noise, which thus solves the problem of decoherence. However, their implementation in the physical world is done at the price of enormous physical resources to reach a sufficient level of protection. The trade-off between the degree of protection ensured by a QECC and the increase in the components necessary for implementation thereof defines what is known as a “resource overhead problem.”

The realistic approaches of quantum computing have to address this problem. To this end, continuous variable systems, like a harmonic oscillator, wherein an infinite dimensional Hilbert space is easily available to protect and process the quantum information, seem to be ahead of discrete variable (DV) systems which have a finite dimensional Hilbert space. There are many different continuous variable encodings, generally involving the superposition of some specific states of a harmonic oscillator, such as the position and motion momentum eigenstates (e.g., GKP qubits), the Fock states, or the coherent states (e.g., cat-qubits).

More particularly, the disclosure relates to cat-qubits.

The pumped, or stabilised, cat-qubits are known to profit from a noise bias. More specifically, an effective error channel (e.g., the bit errors or “bit-flip” errors) is exponentially suppressed with the “size,” (e.g., the average number of photons) of the states of the Schrödinger cat of the cat-qubits. According to current knowledge, this suppression should apply to a large class of physical noise processes having a local effect on the phase space of a harmonic oscillator. This includes, yet is not limited to, photon loss, thermal excitations, photon phase-shift, and various non-linearities induced by coupling to a Josephson junction. Recent experiments, in the context of quantum superconductor circuits, have allowed for observing this exponential suppression of the bit errors with the average number of photons in the cat states.

Because of this noise structure, the quantum error correction is of a complexity that is similar to conventional error correction and may be carried out using a repetition code. Indeed, if it is desired to correct specifically the phase jump, the phase jump error correction code may be applied. For example, this may consist of a repetition code defined in the dual base, or any other conventional error correction code. The space of the code is defined as the common eigenspace+1 of the d−1 stabilisers Sⱼ=Xⱼ⊗Xⱼ₊₁, jϵ [symbol] 1, N−1 [symbol] . The logical operators for the repetition cat-qubit are X_{L}=X₁, Z_{L}=⊗ⱼ Zⱼ, Y_{L}=iX_{L}·Z_{L}. The logical states |+ [symbol] L and |− [symbol] L are given by |± [symbol] _{L}:=|± [symbol] _{c}^{⊗N}.

A repetition code for a cat-qubit is constructed using d number of cat-qubits, which are referred to herein as data cat-qubits, in which the logical information is encoded. The repetition code is implemented such that errors are detected by repeatedly measuring the stabilisers of the repetition code. This is done using d−1 additional cat-qubits, which are referred to herein as ancillary cat-qubits. The quantum circuit of the repetition code requires the preparation in the state |+ [symbol] , which is the Schrödinger cat state in the case of a cat-qubit; the measurement of the Pauli operator X, which is the parity of the number of photons in the case of the cat-qubit; and CNOT gates between the ancillary cat-qubits and the data cat-qubits.

What is difficult in the implementation of this repetition code is how to succeed in making the code function below the fault-tolerant error threshold, which means that the fidelity of the quantum operations in this circuit must be high enough. More specifically, when the repetition code is operating above the threshold, when the fidelity of the physical operations making up the repetition code is not high enough, the lifetime of the logical information decreases when the number of qubits of physical data qubits d increases Thus, the new errors introduced by the addition of quantum systems are not compensated for by the error correction strategy. However, when the code is operated under the error correction threshold, when the fidelity of the physical operations is high enough, the lifetime of the logical information increases exponentially with the number of physical data qubits d, which coincides with the distance d of the repetition code.

The cat-qubits are implemented in the laboratory either by dissipative stabilisation through an artificial biphotonic dissipation at a κ₂ rate, or by Hamiltonian confinement, using a Kerr type Hamiltonian with an amplitude K or a two-photon exchange (TPE) Hamiltonian with an amplitude g₂.

Several articles suggest using cat-qubits in a QECC, either in a code entirely dedicated to the phase error (or “phase-flip”), or in a code that better tolerates phase errors than bit errors (like a biased noise tailored code, of the rectangular surface code or XZZX surface code type), among which “Repetition Cat Qubits for Fault-Tolerant Quantum Computation” by Jeremie Guillaud and Mazyar Mirrahimi, Phys. Rev. X 9, 041053, Dec. 12, 2019, “Bias-preserving gates with stabilised cat qubits” by Shruti et al., SCIENCE ADVANCES, Vol 6, Issue 34, 21 Aug. 2020, “Error rates and resource overheads of repetition cat qubits” by Jeremie Guillaud and Mazyar Mirrahimi, Phys. Rev. A 103, 042413, 13/04/2021, “Building a Fault-Tolerant Quantum Computer Using Concatenated Cat Codes” by Christopher Chamberland et al.; PRX Quantum 3, 010329, 23/02/2022, or “Practical Quantum Error Correction with the XZZX Code and Kerr-Cat Qubits” by Andrew S. Darmawan et al., PRX Quantum 2, 030345, 16/09/2021.

In architectures based on cat-qubits, the quality of the hardware is measured by the ratio between two time scales: the time 1/κ₂, where κ₂ is the two-photon dissipation rate that stabilises the qubit; and 1/κ₁, where κ₁ is the one-photon loss rate. There are other sources of errors like the rate phase-shift κ_{φ}, the thermal excitations nₜₕ, the self-Kerr and cross-Kerr interactions, or other undesirable couplings with other quantum systems present in the vicinity of the memory, etc. Nevertheless, the one-photon loss is the dominant error mechanism and for clarity, the reader is informed that the following discussion focuses on this particular physical error mechanism. In the general case, everything that follows is valid by replacing the κ₁/κ₂ ratio by the sum of the rates of the error mechanisms divided by κ₂.

In the prior art (published works), the κ₁/κ₂ ratio obtained experimentally typically varies from 1 to 10⁻², wherein a smaller value is generally better. However, for the correction of the quantum errors to function, the theoretical predictions estimate that it is necessary to design this ratio so that it is lower than κ₁/κ₂<5×10⁻³. For large-scale quantum computation, it will be necessary to bring this ratio within a range of [10⁻⁵; 10⁻⁴].

Hence, at the present time of writing, there is no solution that allows for implementing a cat-qubit repetition code that is compatible with the fault-tolerant error threshold.

### SUMMARY

The present disclosure thus addresses this major challenge to the scientific community. To this end, the systems and methods herein provide a repetition code for a cat-qubit, which includes a number d of data cat-qubits and at least d−1 ancillary cat-qubits, wherein the number d is greater than or equal to 3. Furthermore, respective ones of the ancillary cat-qubits are connected to two data cat-qubits by two respective CNOT gates such that no data cat-qubit is connected to more than two ancillary cat-qubits, and the two-photon dissipation rate of the ancillary cat-qubits is forced to be greater than the two-photon dissipation rate of the data cat-qubits. This repetition code is implemented by executing, for each ancillary cat-qubit, error correction cycles comprising at least the following operations:
preparing the ancillary cat-qubit in a state suitable for the operator X: “|+ [symbol] ” or “|− [symbol] ”;
activating one of the two CNOT gates connected to this ancillary cat-qubit;
activating the other CNOT gate connected to this ancillary cat-qubit; and
measuring the parity of the number of photons of this ancillary cat-qubit.

This device is particularly advantageous because it allows for implementing a cat-qubit repetition code that is compatible with the fault-tolerant error threshold.

According to various embodiments, the present disclosure may have one or more of the following features.

The two-photon dissipation rate of the ancillary cat-qubits is selected to be substantially equal to a multiple of the two-photon dissipation rate of the data qubits, which multiple is selected from the group including 2, 5, 20, 30 and 50.

The operations listed above for respective error correction cycles are repeated for each ancillary cat-qubit a number of times substantially equal to the ratio of the two-photon dissipation rate of the data cat-qubits to the two-photon loss rate of the ancillary cat-qubits, and then followed by a refresh operation whose duration is in the range of the inverse of the two-photon dissipation rate of the data cat-qubits.

The error correction cycles are implemented substantially simultaneously for respective ones of the ancillary cat-qubits and,
for each ancillary cat-qubit, the operations listed above for respective error correction cycles are carried out sequentially.

Moreover, the data cat-qubits are stabilised in a mode of a 3D cavity using an Asymmetrically Threaded Superconducting Quantum Interference (ATS) circuit,
the ancillary cat-qubits are resonant cat-qubits, and
the ancillary cat-qubits are cat-qubits stabilised in a mode of a 2D resonator using an ATS circuit.

The present disclosure also relates to a surface code for a cat-qubit, which includes a number d of data cat-qubits and at least d−1 ancillary cat-qubits, wherein the number d is greater than or equal to 3. Moreover,
each ancillary cat-qubit is connected to four data cat-qubits by four respective CNOT gates such that no data cat-qubit is connected to more than four ancillary cat-qubits,
the two-photon dissipation rate of the ancillary cat-qubits is forced to be greater than the two-photon dissipation rates of the data cat-qubits, and the
surface code is implemented by executing, for each ancillary cat-qubit, cycles comprising at least the following operations: [symbol]
preparing the ancillary cat-qubit in a state X “|+ [symbol] ” or “|− [symbol] ”;
sequentially activating the CNOT gates connected to this ancillary cat-qubit; and
measuring the parity of the number of photons of this ancillary cat-qubit.

### BRIEF DESCRIPTION OF THE DRAWINGS

Other features and advantages of the present disclosure will appear better upon reading the following description, which is also drawn from examples which are given as a non-limiting illustration, from the drawings, wherein:

FIG. 1 shows a block diagram of a repetition code, according to some embodiments.

FIG. 2A shows an error probability diagram for a CNOT gate performed on an ancillary cat-qubit of the repetition code of FIG. 1, according to some embodiments.

FIG. 2B shows an error probability diagram for a CNOT gate performed on a data cat-qubit of the repetition code of FIG. 1, according to some embodiments.

FIG. 3 shows an implementation diagram of the repetition code of FIG. 1 according to some embodiments.

FIG. 4 shows another implementation diagram of the repetition code of FIG. 1, according to some embodiments.

FIG. 5A shows a first curve of the distortion of the data cat-qubits in the context of the implementation of FIG. 4, according to some embodiments.

FIG. 5B shows a first curve of the distortion of the data cat-qubits in the context of the implementation of FIG. 4, according to some embodiments.

FIG. 5C shows a first curve of the distortion of the data cat-qubits in the context of the implementation of FIG. 4, according to some embodiments.

FIG. 6 shows a top view of an implementation of the repetition code of FIG. 1.

FIG. 7 shows a side view of the implementation of the repetition code introduced in FIG. 6, according to some embodiments.

FIG. 8 shows a top view of another implementation of the repetition code of FIG. 1, according to some embodiments.

FIG. 9 shows a side view of the implementation of the repetition code introduced in FIG. 8, according to some embodiments.

FIG. 10 shows a phase error probability for a symmetrical repetition code of the state of the art, according to some embodiments.

FIG. 11 shows a phase error probability for an asymmetric repetition code that applies the correction cycle of FIG. 4, according to some embodiments.

FIG. 12 shows a block diagram of a surface code, according to some embodiments.

The drawings and the description hereinafter essentially contain elements of a certain nature. Hence, they can be used both to better understand the present disclosure and also contribute to the definition thereof, where appropriate.

### DETAILED DESCRIPTION

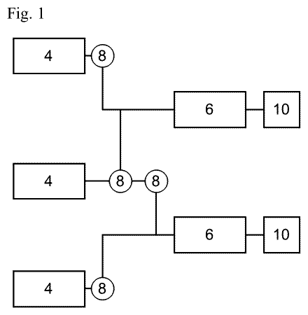

FIG. 1 shows a block diagram of a repetition code according to some embodiments. In the example described herein, the repetition code has a dimension of 3, meaning that it includes three data cat-qubits, labelled as 4 in the figure, and two ancillary cat-qubits, labelled as 6.

By cat-qubit, it should be understood as any implementation of a cat-qubit, and in particular a two-photon dissipative Schrödinger cat-qubit. Alternatively, other cat-qubits could be retained. In some embodiments, the data cat-qubits 4 and the ancillary cat-qubits 6 could be made with distinct types of cat-qubits.

By data cat-qubit, it should be understood that this physical qubit contains the quantum information that the repetition code seeks to protect. By ancillary cat-qubit, it should be understood as the complement of the data cat-qubit in the repetition code, meaning that this physical qubit is used to detect the phase errors of the data cat-qubit.

The repetition code has a conventional repetition code architecture for cat-qubits: a number d greater than or equal to 3 of data cat-qubits 4 and a number d−1 of ancillary cat-qubits 6. In some embodiments, it is also possible to have d ancillary cat-qubits 6 for d data cat-qubits 4. Each ancillary cat-qubit 6 is connected by a CNOT gate, labelled as 8 in the figure, to two data cat-qubits 4. The connections between the data cat-qubits 4 and the ancillary cat-qubits 6 are such that one data cat-qubit 4 is connected to at most two ancillary cat-qubits 6. Each ancillary cat-qubit 6 is also connected to a device, labelled as 10 in the figure, for measuring the parity operator of the number of photons, which is intended to detect the phase errors once the cycle of the error repetition code is implemented.

As additionally explained above, the execution of the repetition code is as follows: (1)
the preparation in the state |+ [symbol] or |− [symbol] , which are the states suitable for the Pauli operator X, for each ancillary cat-qubit; (2)
each CNOT gate, labelled 8, is applied, the CNOT gates 8 associated with the same given ancillary cat-qubit 6 are applied sequentially (e.g., one after another without overlapping), such that the cat-qubit 6 receives the state of the data cat-qubit 4 to which it is connected by a respective CNOT gate 8; and (3)
the measurement of the parity of the number of photons is carried out for each ancillary cat-qubit.

In some embodiments, the same cat-qubits are used for the data cat-qubits 4 as well as for the ancillary cat-qubits 6. Efforts focus on the improvement of the κ₁/κ₂ ratio of the cat-qubits. Nevertheless, this is complicated, and, currently, efforts for improving κ₂ result in a proportional increase of κ₁. More specifically, there are several technologies for stabilising cat-qubits. In general, technologies that allow for having a very low rate κ₁, such as 3D cavities, are technologies for which it is difficult to strongly couple to the cat-qubit, and therefore obtain high values of κ₂. Conversely, some technologies, such as 2D resonators or resonant cat type circuits, allow for obtaining much higher values of κ₂ because it is easier to strongly couple to the cat qubit. However, these circuits are much more difficult to isolate from the environment and therefore have a higher one-photon loss rate κ₁.

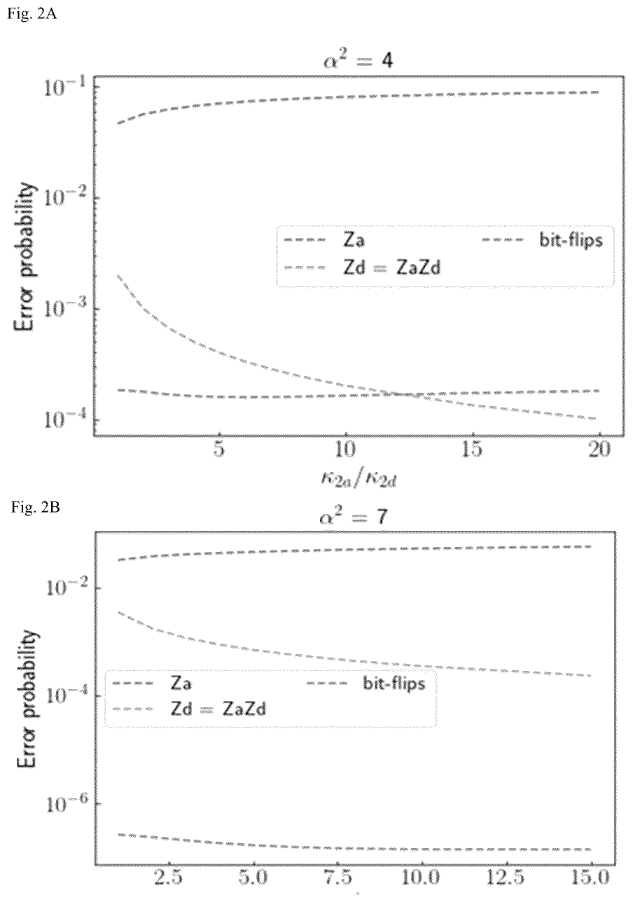

Thus, the present disclosure uses different cat-qubits for the data cat-qubits 4 and the ancillary cat-qubits 6, according to some embodiments. Indeed, the roles of the data cat-qubits 4 and of the ancillary cat-qubits 6 are very different in the repetition code shown in FIG. 1. As additionally explained with regard to FIG. 2, there is an advantage to use, for the same fixed value of κ₁/κ₂, a higher value of κ₂ for the ancillary cat-qubit 6 compared to κ₂ for the data cat-qubit 4.

The interest of such a choice can be explained as follows. The typical time T of an error correction cycle as described with reference to FIG. 1 depends primarily on the time scale set by the two-photon dissipation rate of the ancillary cat-qubits 6. Thus, T=C/κ₂^{ancillary} with C within the range [0.1; 10]. Yet, the typical error rate on the data cat-qubits 4 during this cycle is κ₁^{data}.

In some embodiments in which the ratio between the one-photon loss and the two-photon dissipation is the same for the ancillary cat-qubits 6 and the data cat-qubits 4, then the relationship may be written as δ=κ₁^{ancillary}/κ₂^{ancillary}=κ₁^{data}/κ₂^{data}. However, there is an asymmetry between the ancillary cat-qubits 6 and the data cat-qubits 4, thus Δ=κ₂^{ancillary}/κ₂^{data}=κ₁^{ancillary}/κ₁^{data}.

Yet, it is the total probability of phase-shift error on the data cat-qubits 4 that is most important during a code cycle, and this probability is given by pZ_{data}=κ₁^{data}T=(κ₁^{data}C)/(κ₂^{ancillary})=Cδ/Δ.

FIGS. 2A and 2B show the consequences of this asymmetry.

As shown in FIGS. 2A and 2B, it is possible to digitally assess the errors introduced into the system (ancillary cat-qubits and data cat-qubit) by performing a CNOT gate between two cats. In the presence of a one-photon loss at a fixed relative rate δ=10⁻³ for different asymmetries Δ (according to the X axis), FIG. 2A illustrates a number of photons α²=4, while FIG. 2B illustrates a number of photons α²=7. It should be understood that FIGS. 2A and 2B are given examples, while other values of δ and of α could also be considered and are meant to be encompassed in the discussion herein. For example, the range of interest for α² is in the range of 2 to 20-30 photons at most for a large-scale quantum computer. The time of the CNOT gate is set at T_{CNOT}=1/κ₂^{ancillary}.

The resulting errors can be divided into two categories. There are 12 quantum errors (IX, IY, XI, XX, XY, XZ, YI, YX, YY, YZ, ZX, ZY), which contain a given bit error component on at least one of the cats or both, and these errors are exponentially suppressed with α², as one can verify on the logarithmic scale green curve.

What is interesting is that the behaviour of the three remaining quantum errors which are pure phase changes—which are not exponentially suppressed: the phase changes on the qubit Zₐ of the ancillary cat-qubit (the uppermost curve of the graph, almost flat), those on the qubit Z_{d} of the data cat-qubit (the lowermost curve of the graph, almost flat), and the phase changes correlated on both ZₐZ_{d} (the curve which has the greatest variation between the other two curves except for α²=4, in the plot shown in FIG. 2A, where it passes under the curve of the qubit Z_{d}). FIGS. 2A and 2B are represented on a logarithmic scale. A linear scale representation would show that the errors on the data cat-qubit decrease linearly with the increase in asymmetry Δ.

As explained herein and above, the phase errors on the data cat-qubits (the two curves which are superposed) decrease linearly when the asymmetry Δ is reduced. On the other hand, the pure phase shift on the control qubit increases slightly, but this merely results in measurement errors which barely damage the error correction.

Consequently, the present disclosure proposes a first embodiment of the repetition code shown in FIG. 1—with an asymmetry such that the ratio Δ=κ₂^{ancillary}/κ₂^{data} is within a range [1; 50] with all the possible values of this range, including 2, 5, 20, 30 and 50.

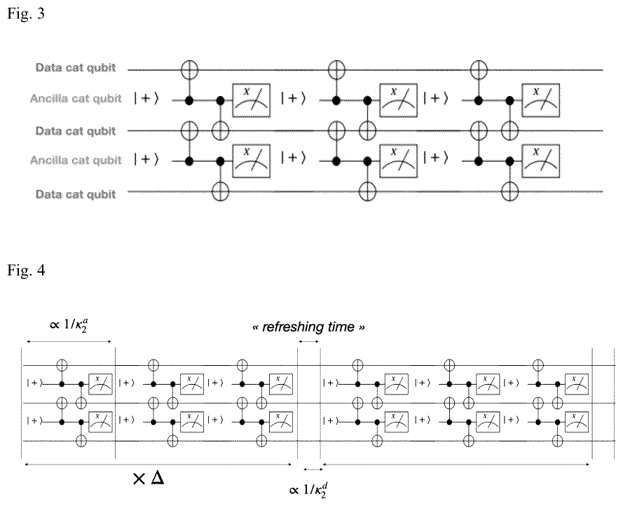

This repetition code, shown in FIG. 1, implements the correction cycle shown in FIG. 3, to the repetition of the following operations:
preparing the ancillary cat-qubit 6 in the state X “|+ [symbol] ” or “|− [symbol] ”;
activating one of the two CNOT gates 8 connected to this ancillary cat-qubit 6;
activating the other CNOT gate 8 connected to this ancillary cat-qubit 6; and
measuring the parity of the number of photons of this ancillary cat-qubit 6.

In FIG. 3, three successive correction cycles are shown, the time elapsing from left to right. Thus, the leftmost elements represent operations that take place at first, two vertically aligned elements indicating simultaneous or almost-simultaneous operations. The operations relating to the data cat-qubits 4 are referenced “data cat-qubit,” and the operations relating to the ancillary cat-qubits 6 are referenced “ancillary cat-qubit”.

The embodiments illustrated in FIG. 3 allows for improving the error tolerance threshold more than twofold.

It has also discovered that this implementation can cause a slight distortion, or leakage, of the data cat-qubits, because the asymmetry Δ of the two-photon dissipation rates leads to gates that are too fast compared to the time scale of the data cat-qubits, given by κ₂^{data}.

Indeed, the gate time is set around

$${T}_{CONT} \approx \frac{1}{{κ}_{2}^{ancillary}} = 1 / Δ {κ}_{2}^{data} .$$

When Δ is increased, the gate is therefore fast compared to the typical time scale 1/Δκ₂^{data}. This leads to a potentially considerable amount of distortion of the data cat-qubit. The fact that data cat-qubits are distorted, wherein a considerable portion of the probability density of the data cat-qubits is no longer in the sub-space of the cat-qubits, could lead to two undesirable effects: (1) the introduction of bit errors that are not exponentially suppressed; and (2) temporal correlations in the measurement errors resulting in higher logical error rates.

Hence, a second embodiment of the correction cycle of the repetition code that is illustrated in FIG. 1 is shown in FIG. 4. In this figure, κ₂^{ancillary} is denoted κ₂^{a} and κ₂^{data} is denoted κ₂^{d}, and the reconvergence mentioned hereinbelow is referenced “refreshing time.”

As shown in FIG. 4, this cycle is quite similar to that of FIG. 3, but it has a refreshing time between A conventional correction cycles.

The idea underlying this second embodiment is to insert “waiting times”, or “refreshing/reconvergence time”, after having performed a given number of error correction cycles, an error correction cycle of the repetition code being composed of the preparation of the ancillary cat-qubits, the application of the two CNOT gates, and the measurement of the ancillary cat-qubits.

During these refreshing times, the two-photon pumping of the data cat-qubits is switched on for a time period that is long enough for the state of these qubits to return into the sub-space of the cat-qubits, e.g., for a time period that is long enough for the distortion of the data cat-qubits induced by the previous measurement cycles to be suppressed.

The typical duration of this refreshing time of the data cat-qubits is in the range of 1/κ₂^{data}. These waiting times necessarily introduce additional phase errors on the data cat-qubits, since these are always subject to error mechanisms during these “long” convergence times. Nonetheless, the present disclosure implements a concatenation of “rapid” error correction cycles, and then refreshes the data cat-qubits following the distortion induced by these rapid cycles, before starting again, allowing for obtaining a performance of the code higher than the symmetric operating mode where the error correction cycles are slower but do not, or barely, distort the data cat-qubits, therefore requiring no refreshing time. The number of error correction cycles that could be performed before a refresh is necessary is typically in the range of the asymmetry Δ=κ₂^{ancillary}/κ₂^{data}.

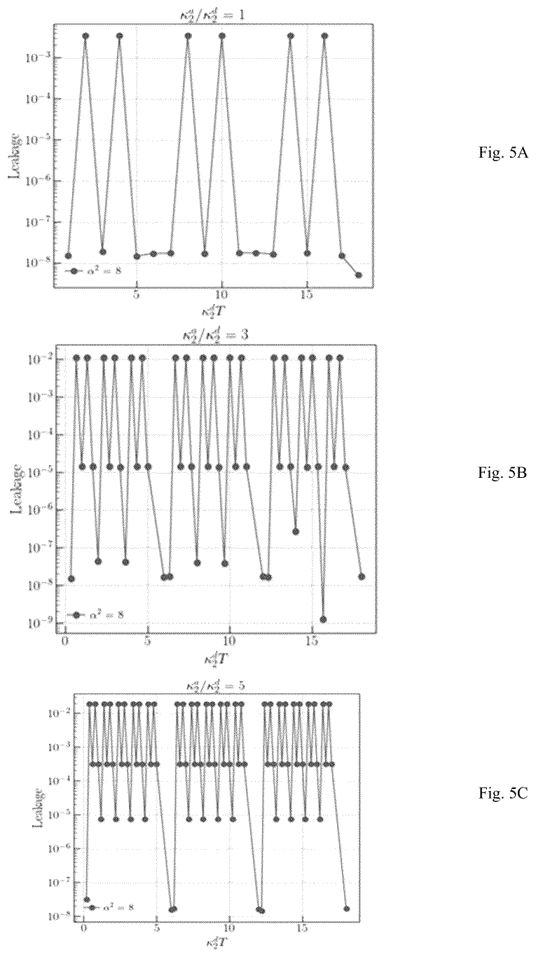

FIGS. 5A, 5B, and 5C illustrate curves showing the distortion of the data cat-qubits that takes place during the implementation of the repetition code with the correction cycle of FIG. 4. In this figure, κ₂^{ancillary} is denoted κ₂^{a} and κ₂^{data} is denoted κ₂^{d}. On the ordinate axis, the reference “Leakage” denotes the distortion rate, e.g., the probability density of the data cat-qubits which is outside the sub-space of the cats as a function of the cycle time. This number varies between 0 and 1:0 when the state of the qubit is perfectly in the subspace, and 1 when there is no longer any. The greater this number, the more the cat-qubit is distorted. On the abscissa axis, the time, units κ₂^{d}T.

Hence, FIGS. 5A, 5B, and 5C show the distortion rate obtained for three different ratios A. It appears that, after each refresh period, the distortion rate returns to its floor, which shows that the correction cycle of FIG. 4 is effective in suppressing the distortion induced by the rapidity of the quantum gates.

Thus, this second embodiment is very advantageous and allows improving the error tolerance threshold by more than 4 fold.

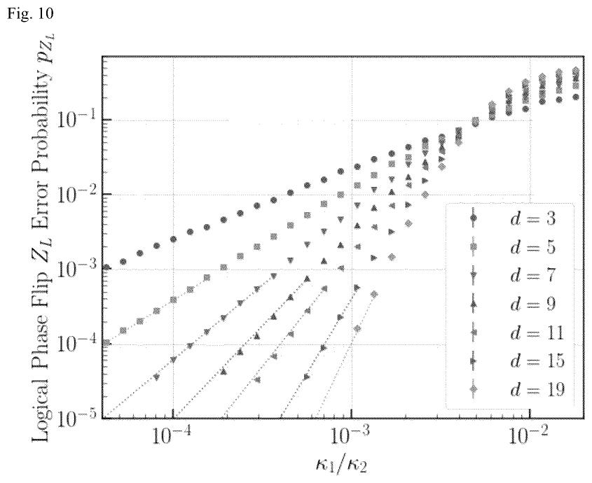

FIG. 10 illustrates the variation of the phase error probability as a function of the dimension d of the repetition code, with a ratio Δ equal to 1, as a function of the value of the ratio S. Since the ratio Δ is equal to 1, we are dealing with a “conventional” repetition code, qualified as “symmetrical”, and this diagram consists of the performance of the state of the art.

To give a few comparison references, for S equal to 0.001 and d equal to 3, the probability is about 0.02. For S equal to 0.003, and for all the values of d, the probability is comprised between 0.02 and 0.06.

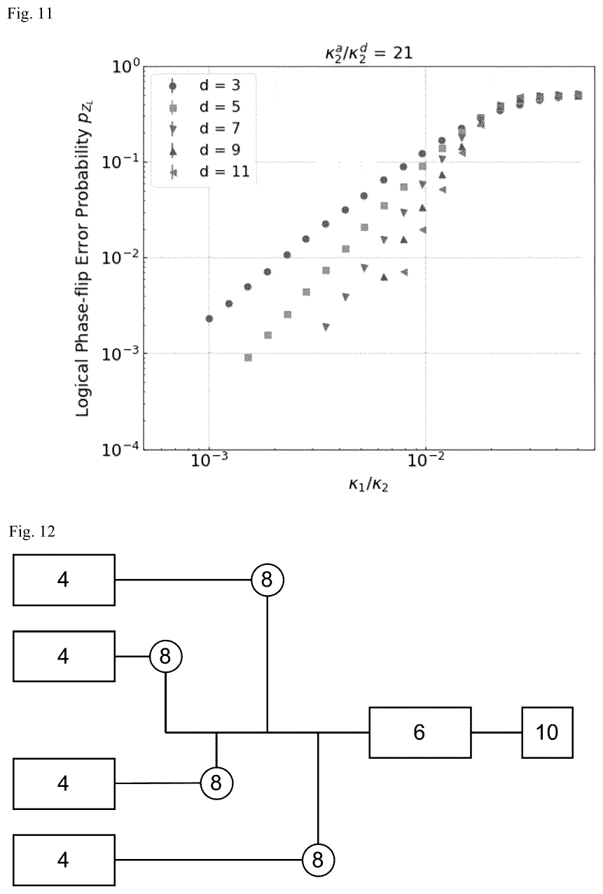

FIG. 11 illustrates the variation of the phase error probability as a function of the dimension d of the repetition code, with a ratio Δ equal to 21, as a function of the value of the ratio S. Since the ratio Δ is equal to 1, the repetition code is the one of the present disclosure—and is qualified as “asymmetric”.

Considering again the values in relation to the state of the art reported in FIG. 10: for S equal to 0.001 and d equal to 3, the probability is now 0.002 (a gain ratio 10 compared to the state of the art); and
for δ equal to 0.003, the probability is 0.02 for d equal to 3 (a gain ratio 3 compared to the state of the art), 0.005 for d equal to 5 (a gain ratio 10 compared to the state of the art), and 0.001 for d equal to 7 (a gain ratio 50 compared to the state of the art).

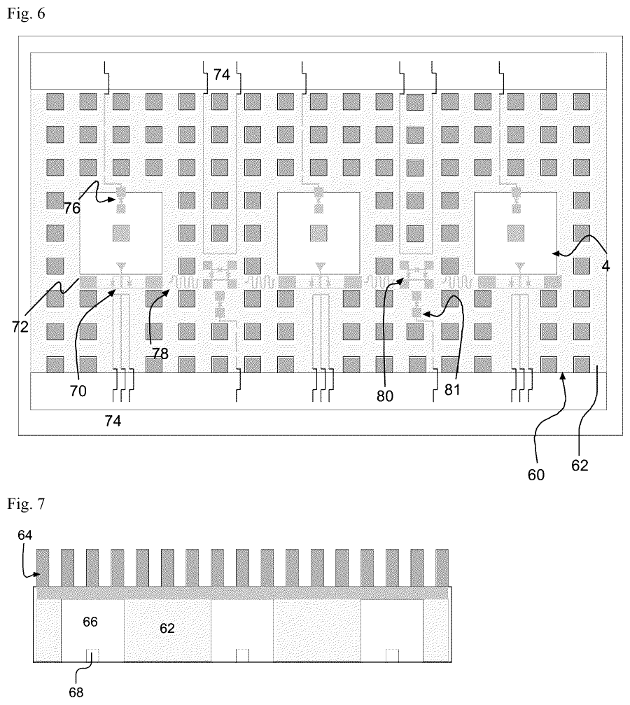

FIGS. 6 and 7 show a “physical” implementation of the repetition code illustrated in FIG. 1.

In this first embodiment implemented in the laboratory, the repetition code of FIG. 1 comprises an electromagnetic isolation device 60 which comprises a base 62 made of an artificial magnetic conductor from which a plurality of projections forming a bed of nails 64 rise. The electromagnetic device 60 comprises a portion which fits above the bed of nails in order to make a forbidden electromagnetic band structure. The bed of nails has a regular pattern of nails 64. The device 60 has been the object of a patent application whose filing number is FR2111275.

The electromagnetic isolation device 60 is intended to confine the electromagnetic field in the 3D cavities of the data cat-qubits 4 described herein and below in order to limit the radiation losses, which reduce the one-photon loss, of the data qubits that are enclosed therein.

Thus, the repetition code of FIG. 1 comprises three data cat-qubits 4 which are herein cat-qubit stabilised in the mode of a 3D cavity allowing reaching typical values

$$\frac{{κ}_{2}}{2 π} = 50 kHz - 100 kHz .$$

The typical values of κ₁ reached by this design are κ₁⁻¹≈100 μs-10 ms.

As shown in FIG. 7, these qubits are implemented in a cavity 66 at the centre of which a finger 68 extends in the same direction as the nails 62. The data cat-qubit 4 is made thanks to an ATS circuit 70.

The ATS circuit 70 comprises a Superconducting Quantum Interference Device (SQUID), which is short-circuited at its centre by a large inductance, which forms two loops and which is surrounded on either side by two pads 72 made of a superconductor material. The ATS circuit 70 is powered by three lines 74, two of which carry the pumping current of the data cat-qubit 4 as well as the flows for the ATS circuit 70 allowing stabilising the qubit. The third line enables a current return for the flows. The ATS circuit 70 has been the object of an American patent application published under the number US 2021/0234086.

The state of the data cat-qubit 4 may be read by means of a conventional device 76. In the example described herein, the device 76 is formed by a transmon comprising two pads and a Josephson junction coupled to a measuring resonator of the transmon coupled to a transmission line. Alternatively, the device 76 could be made in many other manners conventional in the state of the art.

The CNOT gate 8 is made thanks to a transmission line 78 which connects one of the pads 72 to the ancillary cat-qubit 6. This transmission line serves as a “coupler” and allows increasing the participation of the mode of the ancillary cat-qubit 6 in the Josephson junctions of the ATS 70, which allows obtaining a non-linear coupling between the ancillary cat-qubit 6 and the data cat-qubit 4. The CNOT gate 8 may be activated by adding a signal or several signals on the lines 74.

In the example described herein, the ancillary cat-qubit 6 is a 2D resonant cat-qubit 80 which allows reaching typical values

$$\frac{{κ}_{2}}{2 π} = 50 kHz - 100 kHz .$$

The typical values of κ₁ reached by this design are κ₁⁻¹≈1-100 μs. More particularly, the 2D resonant cat-qubit has two modes wa and wb such that wb=2wa, the Schrödinger cat state being stabilised in the wa mode and the wb mode being an auxiliary mode. The ancillary cat-qubit is also powered by a transmission line allowing applying a direct current to control the flow applied at the circuit of the ancillary chat, and also allowing coupling to the auxiliary mode located on the circuit of the ancillary chat. The 2D resonant cat-qubit has been the object of a European patent application published under the number EP21306965.1. A device 81 allows reading the state of the ancillary cat-qubit 6 and implements the device 10. The device 81 may be made in a similar manner as the device 76.

In FIG. 7, some of the nails 64 have been intentionally not shown below the cavities 66 to better show the lines 74. However, these are actually much smaller than the nails 64 and are arranged there between, and the pattern of bed of nails 64 is periodic, except where there are cavities 66.

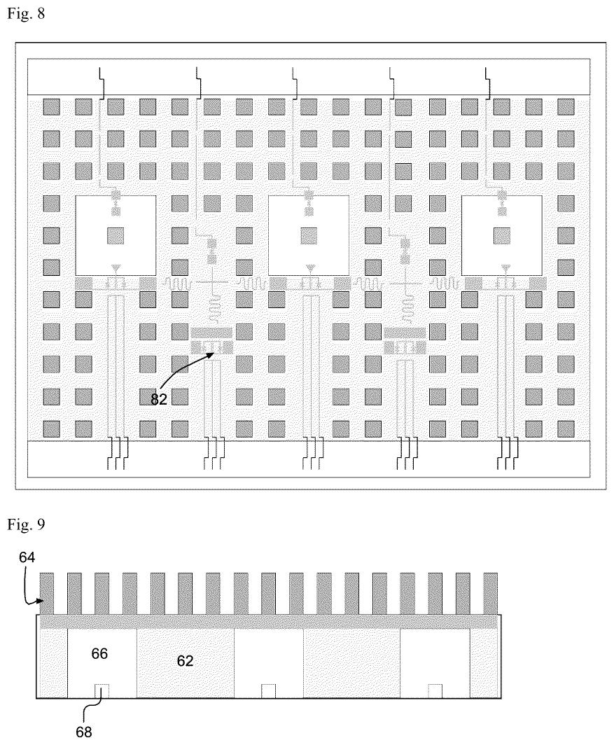

FIGS. 8 and 9 show an alternative implementation. For simplicity, the following discussion focuses on the differences in FIGS. 8 and 9 with respect to FIGS. 6 and 7. In this variant, the cat-qubits 6 are always 2D, but are this time not resonant and are stabilised by an ATS 82.

In the foregoing, the data cat-qubits are always identical to each other. In order to limit the risks of crosstalk due to the frequency crowding phenomenon, the frequencies of the modes of the data cat-qubits could be distinct between spatially neighbouring qubits. This crosstalk would result in the control of one qubit affecting a neighbouring qubit whose resonant mode is at a near frequency. In addition, the data cat-qubits could be made differently from the cat-qubit stabilised in the mode of a 3D cavity. The embodiments of FIGS. 6 to 9 show the generality of the present disclosure and should not be interpreted in a restrictive manner.

The present disclosure also relates to architectures where the cat-qubits are used in an error correction code different from the repetition code. More particularly, the present disclosure also relates to surface code architectures based on cat-qubits.

Indeed, the strategy which includes using a repetition code to correct the phase errors of the cat-qubits is relevant when the noise bias of said cat-qubits is very high, e.g., when the probability of having one single bit error throughout the system (in respective ones of the cat-qubits of the system, and for the entire typical duration of operation of the system; e.g., during the typical execution time of a quantum algorithm on this architecture) is very low compared to the probability of logical phase error.

When the noise bias is not high enough (e.g., because the size of the cat-qubits, measured in number of photons, is not high enough; or when the bit error rate is saturated and no longer increases with the size of the cats, which happens with large numbers of photons when the physical phenomena that cause bit errors are no longer local), it might be interesting to use a surface code instead of the repetition code, which exclusively corrects the phase errors, or another quantum error correction code which also allows tolerating a small number of bit errors.

For these embodiments, the use of ancillary cat-qubits whose two-photon dissipation rate is strictly greater than the two-photon dissipation rate of the data cats also has an advantage, for the same reasons as mentioned hereinabove. Indeed, in the case of the surface code, the stabilisers (the quantum operators to be measured on the data qubits to detect the errors) are in the form Sⱼ=Xⱼ⊗Xⱼ₊₁ ⊗Xⱼ₊₂ ⊗Xⱼ₊₃ and S′ⱼ=Zⱼ ⊗Zⱼ₊₁ ⊗Zⱼ₊₂ ⊗Zⱼ₊₃. For the measurement of the stabilisers Sⱼ, an error correction cycle comprising the preparation of the ancillary cats, the application of 4 CNOT gates, and then the measurement of the operator X of the ancillary cats is carried out. As in the case of the repetition code, the typical speed at which this cycle is carried out depends primarily on the stabilisation rate (two-photon dissipation) of the ancillary cats. Hence, the use of two different technologies for the ancillary cats and the data cats allows improving the performance of the code, and therefore increasing the value of the error correction threshold.

FIG. 12 shows a block diagram of such a surface code.

1. A repetition code for a cat-qubit, comprising a number d of data cat-qubits and at least d−1 ancillary cat-qubits, the number d being greater than or equal to 3, wherein:
each ancillary cat-qubit is connected to two data cat-qubits by two respective CNOT gates such that no data cat-qubit is connected to more than two ancillary cat-qubits;
a two-photon dissipation rate of the ancillary cat-qubits is greater than the two-photon dissipation rate of the data cat-qubits; and
for an execution of the repetition code, a given error correction cycle comprises the following for respective ancillary cat-qubits:
prepare the ancillary cat-qubit in a state suitable for the operator X: “|├+ [symbol] ┤” or “|├− [symbol] ├”;
activate one of the two CNOT gates connected to this ancillary cat-qubit,
activate the other CNOT gate connected to this ancillary cat-qubit, and
measure the parity of the number of photons of this ancillary cat-qubit.

2. The repetition code according to claim 1, wherein the two-photon dissipation rate of the ancillary cat-qubits is selected to be substantially equal to a multiple of the two-photon dissipation rate of the data qubits, wherein the multiple is selected from the group including 2, 5, 20, 30 and 50.

3. The repetition code according to claim 1, wherein the execution of the given error correction cycle is repeated for each ancillary cat-qubit a number of times substantially equal to the ratio of the two-photon dissipation rate of the data cat-qubits to the two-photon loss rate of the ancillary cat-qubits, and then followed by a refresh operation whose duration is in a range of the inverse of the two-photon dissipation rate of the data cat-qubits.

4. The repetition code of claim 1, wherein the error correction cycles are implemented substantially simultaneously for all of the ancillary cat-qubits.

5. The repetition code according to claim 4, wherein, for each ancillary cat-qubit, the execution of the error correction cycles are carried out sequentially.

6. The repetition code according to claim 1, wherein the data cat-qubits are stabilised in a mode of a 3D cavity using an ATS circuit.

7. The repetition code according to claim 1, wherein the ancillary cat-qubits are resonant cat-qubits.

8. The repetition code according to claim 1, wherein the ancillary cat-qubits are cat-qubits stabilised in a mode of a 2D resonator using an ATS circuit.

9. A surface code for a cat-qubit, comprising a number d of data cat-qubits and at least d−1 ancillary cat-qubits, the number d being greater than or equal to 3, wherein:
each ancillary cat-qubit is connected to four data cat-qubits by four respective CNOT gates such that no data cat-qubit is connected to more than four ancillary cat-qubits;
the two-photon dissipation rate of the ancillary cat-qubits is greater than the two-photon dissipation rates of the data cat-qubits;
for an execution of the surface code, a cycle comprises the following for respective ancillary cat-qubits:
preparing the ancillary cat-qubit in a state X “|├ [symbol] ┤” or “|├− [symbol] ┤”;
sequentially activating the CNOT gates connected to this ancillary cat-qubit; and
measuring the parity of the number of photons of this ancillary cat-qubit.

10. The repetition code according to claim 2, wherein the execution of the given error correction cycle is repeated for each ancillary cat-qubit a number of times substantially equal to the ratio of the two-photon dissipation rate of the data cat-qubits to the two-photon loss rate of the ancillary cat-qubits, and then followed by a refresh operation whose duration is in a range of the inverse of the two-photon dissipation rate of the data cat-qubits.
